(19) United States
(12) Patent Application Publication
(10) Pub. No.: US 2008/0200619 A1
(43) Pub. Date: Aug. 21, 2008

(54) Method for Producing a Storage-Stable and Colorless Liquid Polyisocyanate Composition Possessing Carbodiimide and/or Uretonimine Groups

(75) Inventor: Joris Bosman, Herselt (BE)

Correspondence Address: HUNTSMAN INTERNATIONAL LLC, LEGAL DEPARTMENT, 10003 WOODLOCH FOREST DRIVE, THE WOODLANDS, TX, 77380, US

(73) Assignee: Huntsman International LLC, Salt Lake City, UT (US)

(21) Appl. No.: 11/994,692

(22) PCT Filed: Jun. 16, 2006
(86) PCT No.: PCT/EP2006/063271

§ 371 Date: Jan. 4, 2008

(30) Foreign Application Priority Data
Jul. 7, 2005 (EP) 05106178.6

(51) Int. Cl. C08G 18/02

(52) U.S. Cl. 525/453

(57) ABSTRACT

Method for producing a storage-stable and colorless liquid polyisocyanate composition possessing carbodiimide and/or uretonimine groups comprising the steps of a) condensing a polyisocyanate in the presence of a catalyst selected from the group consisting of phospholenes, phospholidines and/or their oxides, and b) stopping the condensation by adding adipoylchloride as catalyst killer.

This invention relates to storage-stable, liquid polyisocyanates possessing carbodiimide and/or uretonimine groups and to a process for their manufacture.

It is known that organic polyisocyanates can be converted to carbodiimides by heating at elevated temperatures, the reaction involving the evolution of carbon dioxide. This process could result in the conversion of all the isocyanate groups in a polyisocyanate to carbodiimide groups but also only a proportion of the isocyanate groups can be converted, usually from 10 to 35%. This then allows the introduction of uretonimine groups into the polyisocyanates, which are formed as adducts of a carbodiimide group and an isocyanate group.

A variety of phosphorus-containing catalysts have been proposed for the conversion of isocyanate groups in organic polyisocyanates into carbodiimide groups.

One class of such catalysts is that comprising amongst others the trialkyl phosphate and phosphoramide types, for example, triethyl phosphate and hexamethyl phosphoramide. This class of catalyst is active at high temperature, for example over 150° C., but has little or no activity at room temperature, for example. For this reason, this class of catalyst has been used in cases where only partial conversion of isocyanate groups to carbodiimide groups is required and after conversion at high temperature, cooling and storage at room temperature, has been found to provide sufficient deactivation of the catalyst, without chemical deactivation, to give acceptable long term storage stability to the product.

However, operation of high temperature processes, apart from being expensive in energy terms, is hazardous due to possible polymerisation of the isocyanate and generates color.

A second class of catalysts for the isocyanate to carbodiimide conversion process are catalysts which are active at much lower temperatures than those mentioned above and therefore preferable in that they avoid use of high temperature with its attendant hazards. This second class based on the phospholidine or phospholene nucleus are however sufficiently active at room temperature as to affect the stability of a product which still contains free isocyanate groups; for this reason they have to be deactivated by chemical or other means.

To terminate the rate of uretonimine formation, a limited amount of acid can be added to the polyisocyanate composition to deactivate the phospholidine or phospholene based catalyst. A preferred known catalyst deactivator is thionyl chloride.

Carbodiimide and/or uretonimine-modified polyisocyanates which have been de-activated using thionylchloride exhibit undesirable yellow coloration.

It is an object of the present invention to manufacture under relatively mild reaction conditions, storage-stable, liquid polyisocyanates possessing carbodiimide and/or uretonimine groups, which do not suffer from the above disadvantage.

Accordingly the present invention provides storage-stable, liquid polyisocyanates being obtained by condensing polyisocyanates in the presence of phospholenes, phospholidines and/or their oxides as a catalyst, and stopping the condensation by means of adipoylchloride.

Using adipoylchloride (Cl—CO—(CH₂)₄—CO—Cl) as killing agent results in a colorless and stable complex with the condensation catalyst. This killing agent is cheap, easily available, easy to handle and not toxic.

The amount of adipoylchloride used for stopping the condensation and at the same time stabilising the end product can be varied within wide limits relative to the amount of catalyst employed. The preferred molar ratio of catalyst to stopper will depend on the reactivity of the polyisocyanate and of the catalyst.

In general, the molar ratio of the catalyst killer over the catalyst itself is generally between 1 and 500, preferably between 5 and 300 and most preferably between 10 and 200. The exact molar ratios can readily be determined by means of laboratory experiments.

The catalysts used for the manufacture of the present polyisocyanates possessing carbodiimide and/or uretonimine groups are phospholenes, phospholidines and/or their oxides. Appropriate phospholenes and phospholidines may be manufactured by reducing the corresponding dichlorophospholenes or dichlorophospholidines with lithium aluminum hydride. These dichloro compounds are also used for the manufacture of phospholene oxides and are described, for example, in U.S. Pat. No. 2,663,736. Phospholene oxides are described in U.S. Pat. Nos. 2,663,737 and 2,663,738 and phospholidine oxides in U.S. Pat. No. 2,663,729. The abovementioned patents are incorporated herein by reference.

Examples of suitable catalysts which may be mentioned are phospholenes, e.g. 1-phenyl-3-phospholene, 3-methyl-1-phenyl-3-phospholene, 1-ethyl-3-phospholene, 3-isopropyl-1-phenyl-3-phospholene and 3-(4-methyl-3-pentenyl)-1-phenyl-3-phospholene, and phospholene oxides, e.g. 3-methyl-1-phenyl-3-phospholene-1-oxide, 1-ethyl-3-methyl-3-phospholene-1-oxide, 1-ethylphenyl-3-methyl-3-phospholene-1-oxide, 3-(4-methyl-3-pentenyl)-1-phenyl-3-phospholene-1-oxide, 3-chloro-1-phenyl-3-phospholene-1-oxide, 1,3-dimethyl-phospholene oxide and 1,3-diphenyl-3-phospholene-1-oxide. Examples of typical phospholidines are 1-phenylphospholidine, 3-methyl-1-phenylphospholidine, 1-ethyl-3-methylphospholidine and 1-ethylphospholidine. Examples of suitable phospholidine oxides are 1-ethyl-3-methyl-phospholidine-1-oxide and 1-phenylphospholidine-1-oxide. Preferred catalysts to use are 1-phenyl-3-methyl-2-phospholene-1-oxide and 1,3-dimethyl-3-methyl-phospholene-1-oxide.

According to the invention, the condensation is carried out in the presence of catalytic amounts of the above catalysts, the exact amount of catalyst for best results depending on the reactivity of the latter and of the polyisocyanate and being readily established by simple laboratory experiments. Generally, the amount of catalyst is from 0.5 to 50 ppm, preferably from 1 to 30 ppm and most preferably from 2 to 15 ppm or from 3 to 7 ppm based on the weight of the polyisocyanate.

The amount of the adipoylchloride in general is between 30 and 3000 ppm based on the weight of the polyisocyanate, preferably between 50 and 1000 ppm, more preferably between 80 and 500 ppm, most preferably between 150 and 500 ppm.

All aliphatic, cycloaliphatic, araliphatic and, preferably, aromatic diisocyanates and/or higher polyisocyanates may be used for the manufacture of the present polyisocyanates containing carbodiimide and/or uretonimine groups. Specific examples which may be mentioned are aliphatic diisocyanates, e.g. tetramethylene-diisocyanate, decamethylene-diisocyanate and preferably hexamethylene-diisocyanate, cycloaliphatic diisocyanates, e.g. 1,4-cyclohexyl-diisocyanate, isophorone-diisocyanate and 4,4′-diisocyanatodicyclohexylmethane, araliphatic diisocyanates, e.g. xylylenediisocyanates and, preferably, aromatic diisocyanates, e.g. 1,3- and 1,4-phenylene-diisocyanate, 1,5-naphthalene-diisocyanate, 2,4- and 2,6-toluylene-diisocyanate and the corresponding isomer mixtures, 2,2′-, 2,4′- and 4,4′-diphenylmethane-diisocyanates and the corresponding isomer mixtures and polyphenyl-polymethylenepolyisocyanates and mixtures of diphenylmethane-diisocyanates and polyphenyl-polymethylene polyisocyanates. The polyisocyanates mentioned may be employed as individual compounds or in the form of mixtures.

The condensation of the diisocyanates and/or higher polyisocyanates, in order to manufacture the polyisocyanates containing carbodiimide and/or uretonimine groups, according to the invention, can be carried out by conventional methods in solution or, preferably, in bulk. Any inert organic solvent can be used where the condensation is carried out in solution. Examples which may be mentioned are substituted and unsubstituted aromatics, e.g. benzene, chlorobenzene, dichlorobenzene, trichlorobenzene, toluene and xylenes, nitromethane, acetonitrile, methyl ethyl ketone, methyl amyl ketone and anisole.

The condensation is in general carried out at a temperature of from 20 to about 150° C., preferably from 80 to 120° C., but of course, it can also be carried out at higher temperatures; though this does not entail advantages.

Since the carbodiimide formation takes place with elimination of carbon dioxide, the course of the reaction can be monitored by, for example, continuous determination of the isocyanate content or measurement of the amount of carbon dioxide eliminated. After reaching a certain isocyanate content—which generally requires condensation times of from 10 minutes to about 24 hours, preferably from about 1 hour to about 6 hours, depending on the starting components, catalysts and reaction parameters—the carbodiimide formation is stopped and at the same time the polyisocyanate possessing carbodiimide groups is stabilised.

The application of the present process could result in the conversion of all the isocyanate groups in the polyisocyanate to carbodiimide groups; the process however has been found particularly useful for the conversion of only a proportion of the isocyanate groups. Preferably from 10 to 35% of the isocyanate groups are converted to carbodiimide groups.

This use of the present process is of value for introducing into the polyisocyanate, uretonimine groups which are formed as adducts of a carbodiimide group and an isocyanate group.

Uretonimine groups are produced by reacting an isocyanate group with a carbodiimide group and may be easily introduced into a polyisocyanate composition by converting some of the isocyanate groups to carbodiimide groups by the present process and then allowing the carbodiimide groups to react with unreacted isocyanate groups to form uretonimine groups. The reaction is reversible and the adduct tends to split into carbodiimide and isocyanate on heating to elevated temperature.

Once carbodiimide groups have been introduced into the polyisocyanate composition, reaction between carbodiimide groups and isocyanate groups takes place with formation of uretonimine groups. In order to permit this reaction to proceed to near completion it is normally necessary to allow the isocyanate/carbodiimide reaction mixture to stand for a time at room temperature. Conversion to uretonimine may not go to absolute completion and there sometimes remains in the composition a small amount of carbodiimide which is not converted to uretonimine despite the presence of excess isocyanate groups.

The polyisocyanates, possessing carbodiimide and/or uretonimine groups, according to the invention, generally have isocyanate contents of from 32 to 24% by weight, preferably from 31 to 26% by weight, based on the total weight of the reaction product, and usually have viscosities of from 10 to 800 cP, preferably from 20 to 250 cP.

The products exhibit excellent storage stability, are liquid and show virtually no color. The Yellowness Index is typically from 1 to 10, preferably from 2 to 7. The Yellowness Index is measured at 50° C. according to a standard method ASTM D1925 using a HunterLab UltraScan I spectrophotometer and Universal Software V3.4.

They may be used in combination with, for example, polyols, e.g. polyesters, polyethers and polyacetals, and the like which contain hydroxyl groups, for the manufacture of foams, coatings, adhesives and elastomers.

The various aspects of this invention are illustrated, but not limited by the following examples.

### EXAMPLE 1

10000 Parts of a mixture of about 98% of 4,4′- and 2% of 2,4′-isomers of methylene(phenylisocyanate) were mixed with 0.05 parts of 3-methyl-1-phenyl-2-phospholene-1-oxide and heated to 110° C. and maintained at that temperature to reach the target end NCO value.

The reaction contents were then cooled and 2.5 parts of adipoylchloride were added to de-activate the catalyst.

The end product was a water white liquid, YI (Yellowness Index) 4.07, NCO value 29.7 wt %.

### EXAMPLE 2 (COMPARATIVE)

In an identical experiment as in Example 1, adipoylchloride was replaced by 0.8 parts of thionylchloride. The end product was yellow (YI 16.92), NCO value 29.5 wt %.

1. A method for producing a polyisocyanate composition possessing carbodiimide and/or uretonimine groups comprising:
condensing a polyisocyanate in the presence of one or more catalysts selected from the group consisting of phospholenes, phospholidines, phosnoholene oxides, and phospholidines oxides; and
stopping the condensation by adding a catalyst killer, wherein said catalyst killer is adipoylchloride.

2. The method of claim 1 including providing the catalyst killer and catalyst in a molar ratio of from 1 to 500.

3-9. (canceled)

10. The method of claim 1 including providing the catalyst killer and catalyst in a molar ratio of from 5 to 300.

11. The method of claim 1 including providing the catalyst killer and catalyst in a molar ratio of from 10 to 200.

12. The method of claim 1 wherein condensing the polyisocyanate in the presence of one or more catalysts includes condensing the polyisocyanate in the presence of the catalyst 3-methyl-1-phenyl-2-phospholene-1-oxide.

13. The method of claim 1 including providing the one or more catalysts in an amount of from 0.5 to 50 ppm based on the weight of the polyisocyanate.

14. The method of claim 1 including providing the one or more catalysts in an amount of from 1 to 30 ppm based on the weight of the polyisocyanate.

15. The method of claim 1 including providing the one or more catalysts in an amount of from 2 to 15 ppm based on the weight of the polyisocyanate.

16. The method of claim 1 including providing the adipoylchloride catalyst killer in an amount of from 30 to 3000 ppm based on the weight of the polyisocyanate.

17. The method of claim 1 including providing the adipoylchloride catalyst killer in an amount of from 50 to 1000 ppm based on the weight of the polyisocyanate.

18. The method of claim 1 including providing the adipoylchloride catalyst killer in an amount of from 80 to 500 ppm based on the weight of the polyisocyanate.

19. The method of claim 1 wherein condensing a polyisocyanate includes condensing an aromatic polyisocyanate.

20. A method comprising manufacturing a foam, a coating, an adhesive, or an elastomer using the polyisocyanate composition produced by the method of claim 1.

21. A polyisocyanate composition possessing carbodiimide and/or uretonimine groups, said polyisocyanate composition obtained by the method defined in claim 1.

22. The polyisocyanate composition of claim 21 having a Yellowness Index of 1 to 10.

23. The polyisocyanate composition of claim 22 having a Yellowness Index of 2 to 7.
